(19) United States
(12) Patent Application Publication
(10) Pub. No.: US 2012/0110818 A1
(43) Pub. Date: May 10, 2012

(54) MACHINE FOR ROTATING A PART AND METHOD FOR DOING THE SAME

(76) Inventors: Leonid Kashchenevsky, Plainville, CT (US); Karl Heilmann, Oldsmar, FL (US)

(21) Appl. No.: 13/290,663

(22) Filed: Nov. 7, 2011

Related U.S. Application Data
(60) Provisional application No. 61/410,639, filed on Nov. 5, 2010.

(51) Int. Cl. B23P 11/00; F16C 32/06

(52) U.S. Cl. 29/428; 384/114

(57) ABSTRACT

A machine for rotating a part includes a rotatable shaft having at least one first surface configured to form a first hydrostatic bearing between the first surface and a substantially cylindrical surface of a part rotationally mountable thereat such that the part rotates coaxially about the substantially cylindrical surface. The machine further includes a stationary fixture having at least one stationary surface having substantially a non-cylindrical shape that is positioned and configured to form a second hydrostatic bearing between the at least one stationary surface and a complementary surface on the part.

### CROSS REFERENCE TO RELATED APPLICATION

This application is a nonprovisional application of U.S. Provisional Patent Application No. 61/410,639, filed Nov. 5, 2010, the entire contents of which are incorporated herein by reference.

### BACKGROUND

A common problem in metrology and machining applications is how to rotate a part precisely coaxially to one of its cylindrical surfaces. The problem becomes significantly more difficult when sub-micron accuracy is required. Additional difficulties arise when fast throughput is required such as during mass production applications. One simple example is illustrated by part 1 in FIG. 1 that has two precision openings, a first opening 2 and a second opening 3. The run-out of surface 4 of the second opening 3 needs to be measured relative to an axis 5 of the first opening 2. Typical systems to measure the run-out is to use high precision and very expensive equipment as with a Round Test Machine, for example (see FIG. 2). The part 1 needs to be centered on a surface 14 of precisely rotating table 8 that is fixed by means of chuck 9. The table 8 rotates around its rotational axis 10. A high sensitivity pick-up sensor 11 with end ball 12 (usually made of a ruby) measures roundness of the first opening 2 at two different locations of cross-sections 6 and 7 (on FIG. 1) and calculates the positions of geometrical centers for the cross-sections 6 and 7. A straight line connecting centers of these cross-sections is considered a geometrical axis 15 of the first opening 2. After the axis 15 is built and saved in memory of the measuring device computer, a roundness of the second opening 3 is measured and a geometrical center of its cross-section is found. A doubled distance between a center of the second opening 3 and an axis of the first opening 2 will be a number describing the surface's 4 run-out relative to the axis 5 of the first opening 2.

For this measurement to be made correctly, the foregoing procedure requires very expensive equipment and highly skilled operators. If an external surface 13 of the part 1 is not finished precisely or if it is not round, the operation to center the part 1 on the table 8 will be time consuming. The distance between the rotational axis 10 of the table 8 and the to be determined geometrical axis 15 of the first opening 2 has to be minimal and less than the measuring range of the sensor 11. Additionally, the likely out of roundness condition as measured at the cross-sections 6 and 7 in the first opening 2 will affect the calculated position of the axis 15 of the first opening 2. The magnitudes of the foregoing difficulties are amplified as precision of machining operations increases. Lets assume, for example, that the precision first opening 2 in the part 1 is finished and that the second opening 3 needs to be ground precisely concentric to the previously finished first opening 2. Current methods and systems are not available to quickly and precisely align the axis of first opening 2 to make it coaxial to the rotational axis of a grinding machine's spindle. The most precise and advanced Round Test Device grinding machines currently available are not capable of making the powerful measurements described above.

Machines and methods to precisely rotate a part about an average geometrical axis of a cylindrical surface on the part are always of interest to those in the art.

### BRIEF DESCRIPTION

Disclosed herein is a machine for rotating a part. The machine includes a rotatable shaft having at least one first surface configured to form a first hydrostatic bearing between the first surface and a substantially cylindrical surface of a part rotationally mountable thereat such that the part rotates coaxially about the substantially cylindrical surface. The machine further includes a stationary fixture having at least one stationary surface having substantially a non-cylindrical shape that is positioned and configured to form a second hydrostatic bearing between the at least one stationary surface and a complementary surface on the part.

Further disclosed herein is a machine for rotating a part. The machine includes, a rotatable shaft having at least one first surface configured to form a hydrostatic bearing with a substantially cylindrical surface of the part and at least one second surface oriented substantially perpendicular to a rotational axis of the rotatable shaft configured to form a second hydrostatic bearing with a second surface of the part, and a stationary fixture having a third surface oriented substantially parallel to the second surface configured to form a third hydrostatic bearing with a third surface of the part.

Further disclosed herein is a method of rotating a part about a geometrical axis of a cylindrical surface thereon with a machine. The method includes, radially hydrostatically supporting the part with a hydrostatic bearing formed between the cylindrical surface of the part and a first surface of a shaft of the machine, longitudinally positioning the part with two hydrostatic bearings urging the part in longitudinally opposing directions, each of the two hydrostatic bearings having one surface of the bearing on the part and an opposing surface of the bearing on the machine, rotating the shaft, and rotating one of two surfaces of the machine defining one of the two hydrostatic bearings while maintaining the other of the two surfaces of the machine stationary.

### BRIEF DESCRIPTION OF THE DRAWINGS

The following descriptions should not be considered limiting in any way. With reference to the accompanying drawings, like elements are numbered alike:

FIG. 1 depicts an example of a part with a surface of a second opening that is to be aligned (as if for machining) precisely coaxially to a first opening;

FIG. 2 depicts a set up configured to measure non-coaxiality between a second opening and a first opening using a Round Test Device;

FIG. 3 depicts a machine disclosed herein that is configured to rotate the part of FIG. 1 coaxial to the first opening;

FIG. 4a depicts a part rotationally supported by stepped journal bearings having inclined surfaces; and

FIG. 4b depicts a cross-sectional view of FIG. 4a taken at arrows A-A illustrating portions of journal bearings defined in part by the inclined surfaces.

### DETAILED DESCRIPTION

A detailed description of one or more embodiments of the disclosed apparatus and method are presented herein by way of exemplification and not limitation with reference to the Figures.

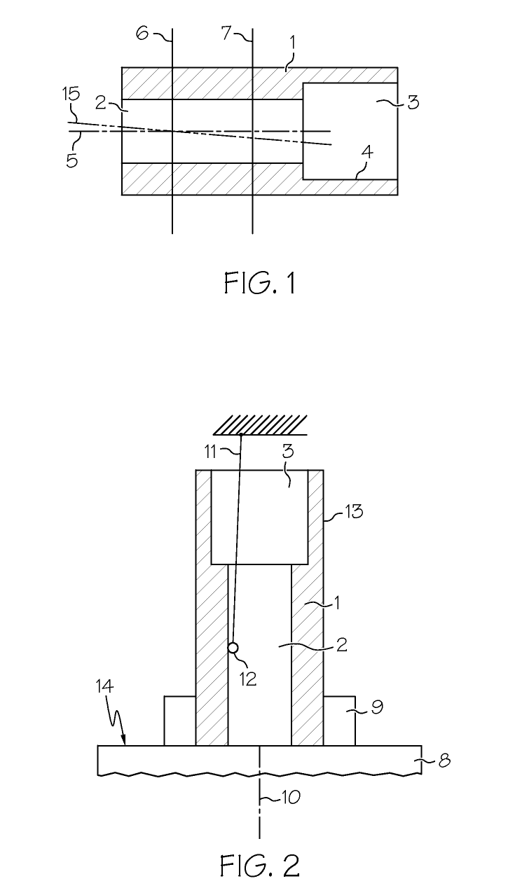

The part 1 shown on the FIG. 1 is used as an example only to describe a machine 16 disclosed herein in detail. Alternate parts having internal or external cylindrical surfaces could just as well be employed to aid in describing the machine 16 disclosed herein.

Referring to FIG. 2, a spindle housing 20 is mounted on the base 21. Technological shaft 23 is clamped to the rotating spindle's shaft 22 by means of the technological shaft's flange 24. The technological shaft 23 has two independent rows of hydrostatic journal bearings 29 and 30 shown schematically as cylindrical surfaces. An annular groove 27 in the flange 24 functions as an axial thrust hydrostatic bearing 27. A non-rotating fixture 25 is mounted to the non-rotating spindle housing 20 and supports a cover 26 that includes an annular groove 28 configured to preload the axial thrust hydrostatic bearing 27.

A part 31 to be rotated is mounted onto the shaft 23 and is radially separated from the shaft by journal hydrostatic bearings 29 and 30. Axial separation between the part 31 and the flange 24 is maintained by the axial thrust hydrostatic bearing 27. The bearing 27 is preloaded with via pressurized fluid such as oil, for example, supplied to the annular groove 28 through channel 35.

Similarly, oil is supplied to recesses 33 of the journal bearings 29 and 30 through a channel 44 and inlet restrictors 43. Oil is also supplied to the thrust bearing groove 27 through channel 36 and inlet restrictor 37.

As the spindle shaft 22 and the technological shaft 23 attached thereto start to rotate, the part 31 will also start to rotate because of viscous friction in oil in the grooves 27, 28 and the recesses 33, as well as the gaps 34 that straddle each of the grooves 27, 28 and each of the recesses 33. The viscous friction between the shaft 23 and part 31 will transfer torque to the part 31 in the direction of rotation, while the viscous friction between the part 31 and the non-rotating cover 26 will transfer torque to the rotating spindle shaft 22 against the direction of rotation. As a result of these frictional forces, the rotational speed of the part 31 will be lower than the rotational speed of the shaft 23. The ratio between the rotational speed of the part 31 and the rotational speed of the shaft 23 will be defined by a ratio between frictional torque urging the part 31 to rotate and frictional torque urging the part 31 not to rotate.

The foregoing structure of the machine 16 will cause the part 31 to rotate exactly around its geometrical axis 15. The machine 16 causes an internal surface 41 of the first opening 2 of the part 31 to generate rotation about itself. This is helpful because it is the internal surface 41 that needs to be aligned coaxial to the geometrical axis 15. Additionally, since hydrostatic support will average the geometrical errors in the first opening 2 of the part 31, the described method can be even more accurate than the most precise Round Test Devices.

Oil that makes its way from the grooves 27, 28 and the recesses 33 through the gaps 34 and into annular chambers 38, 39 and 42 is ported back to a hydraulic power unit through lines that are not shown. Oil that makes its way from the annular preloading groove 28 and the recess 33 of the journal bearing 30 through the gaps 34 and into the chamber 40 can be directed to the surface 4 of the opening 3, wherein it can be either ported back to the hydraulic power unit or it can be used as a grinding coolant in the case where the surface 4 is to be machined.

Equations to quantify rotational speeds based upon frictional forces include the following: Frictional torque that urges the part 31 to rotate is designated M₁, and frictional torque that urges the part 31 to stop rotating is designated M₂. Because the frictional torques caused by the oil viscosity are proportional to the relative speed between matched surfaces, the torques M₁ and M₂ can be expressed as follows:

M₁=K₁(ω₁−ω) (1)

M₂=K₂ω (2)

where ω₁ is the rotational speed of shafts 22 and 23, ω is the speed of the part 31, K₁ and K₂ are proportionality coefficients depending on oil viscosity, the gaps 34 (both radial and axial) and sizes of the matched surfaces.

The dynamic equation of rotational speed ω for the part 31 can be written as follows:

$$J \frac{d ω}{d t} = {M}_{1} - {M}_{2} = {K}_{1} ( {ω}_{1} - ω ) - {K}_{2} ω \qquad ( 3 )$$

where J is the inertia moment of the part 31. Speed will be stabilized when the right portion of equation (3) is equal to zero. As such, the equation for the speed ω can be written:

K(ω₁−ω)−K₂ω=0 (4)

and, finally, the part's 31 rotational speed ω will be expressed through the spindle shaft's 22 and the technological shaft's 23 rotational speeds ω₁ in the following way:

$$ω = \frac{{K}_{1}}{{K}_{1} + {K}_{2}} {ω}_{1} \qquad ( 5 )$$

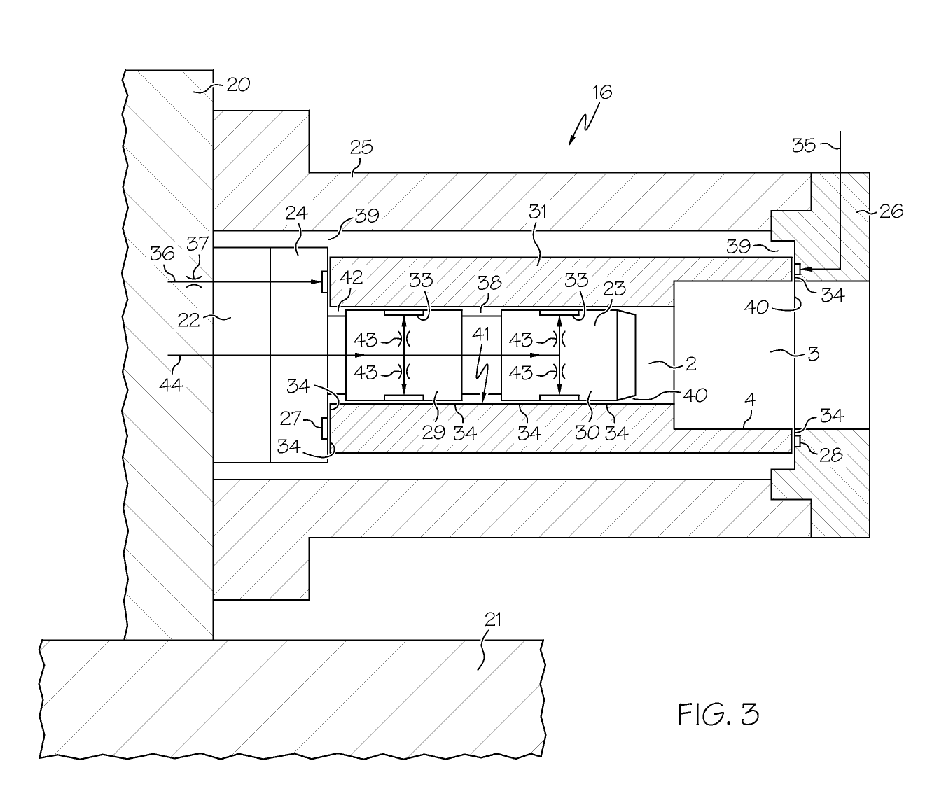

It should be noted that the machine 16 disclosed in FIG. 3 can employ any hydrostatic journal bearings between the part 31 and the technological shaft 23. For example stepped hydrostatic bearings that do not require separately inlet restrictors could be used. One type bearing that also increases a radial stiffness and load capacity of the bearing is a journal stepped bearing similar to that disclosed in the U.S. Pat. No. 3,387,899 by Robert Hahn and David Youden.

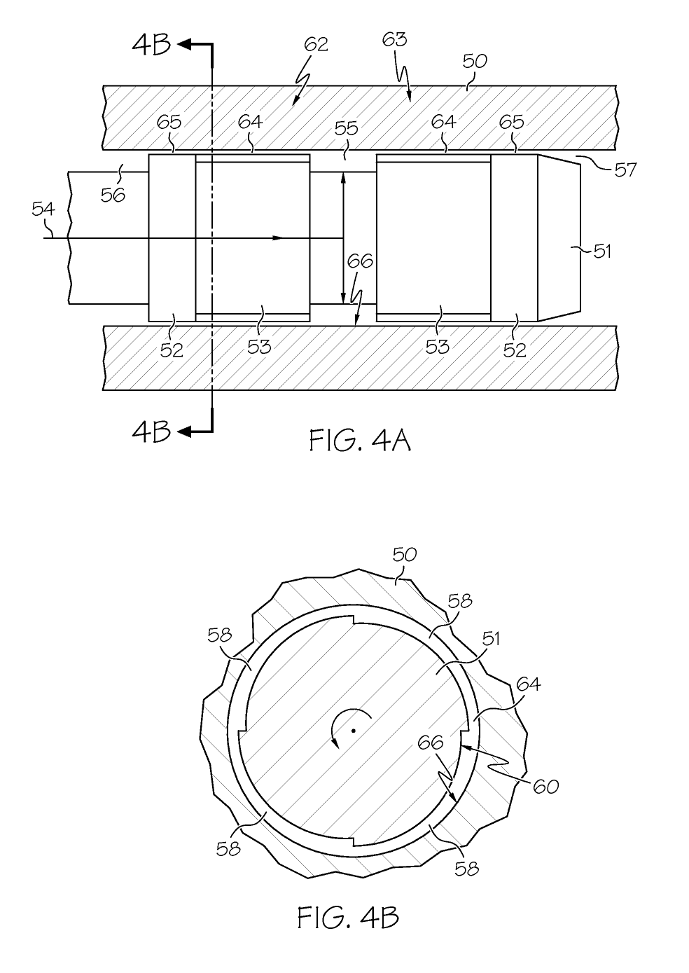

Referring to FIGS. 4a and 4b, a partial cross-sectional view of a technological shaft 51 of an alternate embodiment of the machine disclosed herein is illustrated. The shaft 51 provides radial support to a part 50. The shaft 51 has two independent stepped journal bearings 62, 63 with each having a cylindrical portion 52 and non-cylindrical portion 53. The non-cylindrical portions 53 have a number of inclined surfaces 60 defining gaps 58 having varying radial dimensions between the inclined surfaces 60 and the part 50 (as best seen in FIG. 4b). The minimal gap 64 between the inclined surfaces 60 and an internal surface 66 of the part 50 is larger or equal to annular gaps 65 defined between the cylindrical portions 52 and the internal surface 66. High pressure liquid media, such as oil, for example, is supplied to annular chamber 55 through passage 54. From the chamber 55 oil moves through the gaps 58 and 65 to annular chambers 56 and 57. From chamber 56, oil is collected and returned back to a hydraulic power unit (not shown). Oil moving to the chamber 57 can either be collected and returned to the hydraulic power unit or be used as a coolant for a grinding process.

A hydrostatic component of the radial stiffness is generated by a difference between a size of the annular gap 65 in the cylindrical portions 52 and an average size of the gaps 58 in the non-cylindrical portions 53 (in a similar manner as is used in a typical stepped hydrostatic bearings).

A hydrodynamic component of the radial stiffness is generated by oil pressure distributed to the inclined gaps 58 of the non-cylindrical portions 53. The hydrostatic portion of stiffness is defined mainly by supply pressure, while the hydrodynamic portion is defined mainly by and is proportional to differences in rotational speeds between the shaft 51 and the part 50.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A machine for rotating a part, comprising:
a rotatable shaft having at least one first surface configured to form a first hydrostatic bearing between the first surface and a substantially cylindrical surface of a part rotationally mountable thereat such that the part rotates coaxially about the substantially cylindrical surface; and
a stationary fixture having at least one stationary surface having substantially a non-cylindrical shape being positioned and configured to form a second hydrostatic bearing between the at least one stationary surface and a complementary surface on the part.

2. The machine for rotating a part of claim 1, wherein the first hydrostatic bearing is a journal bearing.

3. The machine for rotating a part of claim 1, wherein the at least one stationary surface is substantially orthogonal to an axis of rotation of the rotatable shaft.

4. The machine for rotating a part of claim 1, further comprising at least one third surface rotatable and positioned and configured to form a third hydrostatic bearing between the third surface and a second complementary surface on the part.

5. The machine for rotating a part of claim 4, wherein the third surface rotates with the rotatable shaft.

6. The machine for rotating a part of claim 4, wherein the third surface is substantially orthogonal to an axis of rotation of the rotatable shaft.

7. The machine for rotating a part of claim 6, wherein the part is longitudinally compressed between the second surface and the third surface.

8. The machine for rotating a part of claim 6, wherein rotational speed of the part is calculable based on rotational speed of the rotatable shaft, viscosity of fluid employed in the hydrostatic bearings and geometric properties of the hydrostatic bearings.

9. The machine for rotating a part of claim 1, wherein the at least one first surface is an external cylindrical surface.

10. The machine for rotating a part of claim 1, wherein the rotatable shaft includes at least one channel through which fluid is provided to the first hydrostatic bearing.

11. The machine for rotating a part of claim 1, wherein the at least one first surface is two first surfaces and each of the two first surfaces are configured to form hydrostatic bearings between the two first surfaces and the substantially cylindrical surface of the part.

12. The machine for rotating a part of claim 1, wherein the rotatable shaft includes at least one portion having a stepped surface to thereby generate hydrodynamic bearing stiffness proportional to differences in rotational speed between the rotatable shaft and the part.

13. The machine for rotating a part of claim 12, wherein the at least one stepped surface has a plurality of inclined surfaces.

14. The machine for rotating a part of claim 1, wherein the part rotating machine is a grinding machine.

15. The machine for rotating a part of claim 1, wherein the rotational axis of the part is based on a geometrical average of the substantially cylindrical surface.

16. The machine for rotating a part of claim 1, wherein the stationary fixture includes at least one channel through which fluid is provided to the second hydrostatic bearing.

17. A machine for rotating a part, comprising:
a rotatable shaft having at least one first surface configured to form a hydrostatic bearing with a substantially cylindrical surface of the part and at least one second surface oriented substantially perpendicular to a rotational axis of the rotatable shaft configured to form a second hydrostatic bearing with a second surface of the part; and
a stationary fixture having a third surface oriented substantially parallel to the second surface configured to form a third hydrostatic bearing with a third surface of the part.

18. A method of rotating a part about a geometrical axis of a cylindrical surface thereon with a machine, comprising:
radially hydrostatically supporting the part with a hydrostatic bearing formed between the cylindrical surface of the part and a first surface of a shaft of the machine;
longitudinally positioning the part with two hydrostatic bearings urging the part in longitudinally opposing directions, each of the two hydrostatic bearings having one surface of the bearing on the part and an opposing surface of the bearing on the machine;
rotating the shaft; and
rotating one of two surfaces of the machine defining one of the two hydrostatic bearings while maintaining the other of the two surfaces of the machine stationary.

19. The method of rotating a part about a cylindrical surface thereon with a machine of claim 18, wherein the rotating one of the two surfaces of the machine is at a rotational speed equal to that of the shaft.

20. The method of rotating a part about a cylindrical surface thereon with a machine of claim 18, further comprising rotating the part at a rotational speed less than the rotational speed of the shaft.
